(19) United States
(12) Patent Application Publication
(10) Pub. No.: US 2024/0340793 A1
(43) Pub. Date: Oct. 10, 2024

(54) MONITORING METHOD AND APPARATUS, TERMINAL, AND NETWORK DEVICE

(71) Applicant: SPREADTRUM SEMICONDUCTOR (NANJING) CO., LTD., Nanjing, Jiangsu (CN)

(72) Inventors: Zhenzhu LEI, Nanjing, Jiangsu (CN); Huayu ZHOU, Nanjing, Jiangsu (CN)

(21) Appl. No.: 18/579,386

(22) PCT Filed: Jul. 14, 2022
(86) PCT No.: PCT/CN2022/105822

§ 371 Date: Jan. 15, 2024

(30) Foreign Application Priority Data
Jul. 15, 2021 (CN) 202110804590.3

(51) Int. Cl. H04W 52/02; H04W 76/27

(52) U.S. Cl. CPC H04W 52/0235; H04W 76/27

(57) ABSTRACT

A monitoring method and apparatus, a terminal, and a network device are provided. The method includes the following. A network device configures a first timer, where the first timer is started after a first wake-up signal (WUS) is monitored by a terminal. After the first WUS is monitored, the terminal starts the first timer. Before the first timer expires, the terminal monitors first paging downlink control information (DCI) or a second WUS. The first WUS is used for triggering start of the first timer by the terminal, the second WUS is used for triggering start of the second timer by the terminal, and a duration of the second timer represents a duration for the terminal to monitor a second paging DCI.

### CROSS-REFERENCE TO RELATED APPLICATION(S)

This application is a National Stage of International Application No. PCT/CN2022/105822, field Jul. 14, 2022, which claims priority to Chinese Patent Application No. 2021108045903, filed Jul. 15, 2021, the entire disclosures of which are hereby incorporated by reference.

### TECHNICAL FIELD

This disclosure relates to the field of communication technology, and more particularly, to a monitoring method and apparatus, a terminal, and a network device.

### BACKGROUND

If a terminal is in a radio resource control (RRC) idle (RRC_IDLE) state or an RRC inactive (RRC_INACTIVE) state, the terminal may determine, according to an indication of a wake-up signal (WUS), whether to monitor a paging occasion (PO) corresponding to the WUS, which can prevent the terminal from always monitoring a PO in a paging cycle, thereby reducing power consumption of the terminal.

With continuous evolution of standard protocols formulated by the 3^{rd} generation partnership project (3GPP) and continuous increase in complexity of communication scenarios, to prolong the battery life of the terminal to a duration of several weeks or even several years, 3GPP is currently discussing issues related to introducing a new WUS (for example, a low-power WUS), as well as scenarios of using the new WUS to wake up the terminal in a non-RRC_IDLE state or in a non-RRC_INACTIVE state so as to reduce power consumption.

To this end, the problem regarding a function of the new WUS and how to use together with an existing WUS to further reduce power consumption of the terminal needs further study.

### SUMMARY

In a first aspect, a monitoring method is provided in the disclosure. The method includes the following. After a first WUS is monitored, a terminal starts a first timer. Before the first timer expires, the terminal monitors a first paging DCI or a second WUS, where the second WUS is used for triggering start of a second timer by the terminal, and a duration of the second timer represents a duration for the terminal to monitor a second paging DCI.

In a second aspect, a terminal is provided in the disclosure. The terminal includes a processor, a memory, a communication interface, and at least one program. The at least one program is stored in the memory and configured to be executed by the processor, and the at least one program includes instructions for implementing the steps in the first aspect of the disclosure.

In a third aspect, the disclosure provides a non-transitory computer-readable storage medium. The computer-readable storage medium is configured to store computer programs and data for electronic data interchange (EDI). The computer programs and data are operable with a computer to implement some or all of the steps described in the first aspect or the second aspect of the disclosure.

### BRIEF DESCRIPTION OF THE DRAWINGS

In order to describe more clearly technical solutions of embodiments of the disclosure, the following will give a brief introduction to the accompanying drawings used for describing the embodiments or the related art.

FIG. 1 is a schematic architectural diagram of a wireless communication system provided in embodiments of the disclosure.

FIG. 2 is a schematic flowchart of a monitoring method provided in embodiments of the disclosure.

FIG. 3 is a schematic structural diagram illustrating a duration of a first timer provided in embodiments of the disclosure.

FIG. 4 is another schematic structural diagram illustrating a duration of a first timer provided in embodiments of the disclosure.

FIG. 5 is another schematic structural diagram illustrating a duration of a first timer provided in embodiments of the disclosure.

FIG. 6 is a schematic flowchart of another monitoring method provided in embodiments of the disclosure.

FIG. 7 is a schematic flowchart of another monitoring method provided in embodiments of the disclosure.

FIG. 8 is a block diagram illustrating functional units of a monitoring apparatus provided in embodiments of the disclosure.

FIG. 9 is a block diagram illustrating functional units of another monitoring apparatus provided in embodiments of the disclosure.

FIG. 10 is a schematic structural diagram of a terminal provided in embodiments of the disclosure.

FIG. 11 is a schematic structural diagram of a network device provided in embodiments of the disclosure.

### DETAILED DESCRIPTION

In order for those skilled in the art to better understand technical solutions of the disclosure, technical solutions of embodiments of the disclosure will be described below with reference to the accompanying drawings in the embodiments of the disclosure. Apparently, the embodiments described herein are merely some embodiments, rather than all embodiments, of the disclosure. Based on the embodiments of the disclosure, all other embodiments obtained by those of ordinary skill in the art without creative effort shall fall within the protection scope of the disclosure.

The terms “first”, “second”, and the like in the specification and claims of the disclosure, and above accompanying drawings are used to distinguish different objects, rather than describe a particular order. In addition, the terms “include”, “comprise”, and “have” as well as variations thereof are intended to cover non-exclusive inclusion. For example, a process, method, software, product, or device including a series of steps or units is not limited to the listed steps or units, and instead, it can optionally include other steps or units that are not listed or other steps or units inherent to the process, method, product, or device.

The term “embodiment” referred to in embodiments of the disclosure means that a particular feature, structure, or characteristic described in conjunction with the embodiment may be contained in at least one embodiment of the disclosure. The phrase appearing in various places in the specification does not necessarily refer to the same embodiment, nor does it refer to an independent or alternative embodiment that is mutually exclusive with other embodiments. It is explicitly and implicitly understood by those skilled in the art that an embodiment described herein may be combined with other embodiments.

It should be noted that, the terms “connection” appearing in the embodiments of the disclosure refers to various connection manners, such as direct connection or indirect connection, so as to implement communication between devices, which is not limited herein. The terms “network” and “system” in the embodiments of the disclosure refer to the same concept, and a communication system is a communication network.

The technical solutions of the embodiments of the disclosure may be applied to various wireless communication systems, for example, a global system of mobile communication (GSM), a code division multiple access (CDMA) system, a wideband code division multiple access (WCDMA) system, a general packet radio service (GPRS), a long term evolution (LTE) system, an advanced LTE (LTE-A) system, a new radio (NR) system, an evolved system of an NR system, an LTE-based access to unlicensed spectrum (LTE-U) system, an NR-based access to unlicensed spectrum (NR-U) system, a non-terrestrial network (NTN) system, a universal mobile telecommunication System (UMTS), a wireless local area network (WLAN), a wireless fidelity (WiFi), a 6^{th}-generation (6G) communication system, or other communication systems.

It should be noted that, a conventional wireless communication system generally supports a limited quantity of connections and therefore is easy to implement. However, with development of communication technology, a wireless communication system will not only support a conventional wireless communication system but also support, for example, device to device (D2D) communication, machine to machine (M2M) communication, machine type communication (MTC), vehicle to vehicle (V2V) communication, vehicle to everything (V2X) communication, narrowband internet of things (NB-IoT) communication, etc. Therefore, the technical solutions of the embodiments of the disclosure can also be applied to these wireless communication systems.

Optionally, the wireless communication system in the embodiments of the disclosure may be applied to a beamforming scenario, a carrier aggregation (CA) scenario, a dual connectivity (DC) scenario, or a standalone (SA) deployment scenario, etc.

Optionally, the wireless communication system in the embodiments of the disclosure may be applied to an unlicensed spectrum, where the unlicensed spectrum may also be considered as a shared spectrum. Alternatively, the wireless communication system in the embodiments may be applied to a licensed spectrum, where the licensed spectrum may also be considered as a non-shared spectrum.

Since various embodiments of the disclosure are described in connection with a terminal and a network device, the terminal and the network device involved will be described in detail below.

Specifically, the terminal may be a user equipment (UE), a remote UE, a relay UE, an access terminal, a subscriber unit, a subscriber station, a mobile station, a remote station, a mobile device, a user terminal, a smart terminal, a wireless communication device, a user agent, or a user apparatus. It should be noted that, a relay device is a terminal capable of providing a relay forwarding service for other terminals (including a remote terminal). In addition, the terminal may also be a cellular radio telephone, a cordless telephone, a session initiation protocol (SIP) telephone, a wireless local loop (WLL) station, a personal digital assistant (PDA), various devices having wireless communication functions such as a handheld device, a computing device or other processing devices coupled with a wireless modem, an in-vehicle device, a wearable device, a terminal in a next-generation communication system (such as an NR communication system, a 6G communication system), or a terminal in a future evolved public land mobile network (PLMN), etc., which is not limited herein.

In addition, the terminal may be deployed on land, which includes indoor or outdoor, handheld, wearable, or in-vehicle. The terminal may also be deployed on water (such as ships, etc.). The terminal may also be deployed in the air (such as airplanes, balloons, satellites, etc.).

In addition, the terminal may be a mobile phone, a pad, a computer with wireless transceiver functions, a virtual reality (VR) terminal device, an augmented reality (AR) terminal device, a wireless terminal device in industrial control, a wireless terminal device in self driving, a wireless terminal device in remote medicine, a wireless terminal device in smart grid, a wireless terminal device in transportation safety, a wireless terminal device in smart city, or a wireless terminal device in smart home, etc.

Specifically, the network device may be a device for communicating with the terminal, and is responsible for radio resource management (RRM), quality of service (QoS) management, data compression and encryption, and data transmission and reception at an air-interface side. The network device may be a base station (BS) in a communication system or a device deployed on a radio access network (RAN) for providing wireless communication functions, for example, a base transceiver station (BTS) in a GSM or CDMA communication system, a node B (NB) in a WCDMA communication system, and an evolutional node B (eNB or eNodeB) in an LTE communication system, a next generation evolved node B (ng-eNB) in an NR communication system, a next generation node B (gNB) in an NR communication system, a master node (MN) in a DC architecture, a secondary node (SN) in a DC architecture, etc, which is not limited herein.

In addition, the network device may also be other devices in a core network (CN), such as an access and mobility management function (AMF), a user plane function (UPF), etc., or may be an access point (AP) in a WLAN, a relay station, a communication device in a future evolved PLMN, a communication device in an NTN network, etc.

In addition, the network device may include an apparatus, such as a system-on-chip (SOC), that has functions of providing wireless communication for the terminal. Exemplarily, the SOC may include a chip, and may further include other discrete devices.

In addition, the network device may communicate with an internet protocol (IP) network, for example, the Internet, a private IP network, or other data networks.

It should be noted that, in some network deployments, the network device may be an independent node so as to implement all functions of the base station, and may include a centralized unit (CU) and a distributed unit (DU), such as a gNB-CU and a gNB-DU. The network device may further include an active antenna unit (AAU). The CU can implement some functions of the network device, and the DU can also implement some other functions of the network device. For example, the CU is responsible for processing non-real-time protocols and services, and implements functions of a radio resource control (RRC) layer, functions of a service data adaptation protocol (SDAP) layer, and functions of a packet data convergence protocol (PDCP) layer. The DU is responsible for processing physical (PHY) layer protocols and real-time services, and implements functions of a radio link control (RLC) layer, functions of a media access control (MAC) layer, and functions of a PHY layer. In addition, the AAU can implement some PHY layer processing functions, radio frequency processing functions, and active-antenna related functions. Since RRC layer information will eventually become PHY layer information, or be transformed from PHY layer information, in such network deployment, it may be considered that higher layer signaling, such as RRC layer signaling, is transmitted by the DU, or transmitted by the DU and the AAU. It can be understood that, the network device may include at least one of the CU, the DU, or the AAU. In addition, the CU may be categorized into a network device in a RAN, or may be categorized into a network device in a CN, and the disclosure is not limited in this regard.

In addition, the network device may be mobile. For example, the network device may be a mobile device. Optionally, the network device may be a satellite or a balloon base station. For example, the satellite may be a low earth orbit (LEO) satellite, a medium earth orbit (MEO) satellite, a geostationary earth orbit (GEO) satellite, a high elliptical orbit (HEO) satellite, etc. Optionally, the network device may also be a base station deployed on land or water.

In addition, the network device may serve a cell, and the terminal may communicate with the network device over a transmission resource (for example, a frequency-domain resource or a spectrum resource) for the cell. The cell may include a macro cell, a small cell, a metro cell, a micro cell, a pico cell, and a femto cell, etc.

With reference to the foregoing elaborations, a wireless communication system in embodiments of the disclosure will be exemplified below.

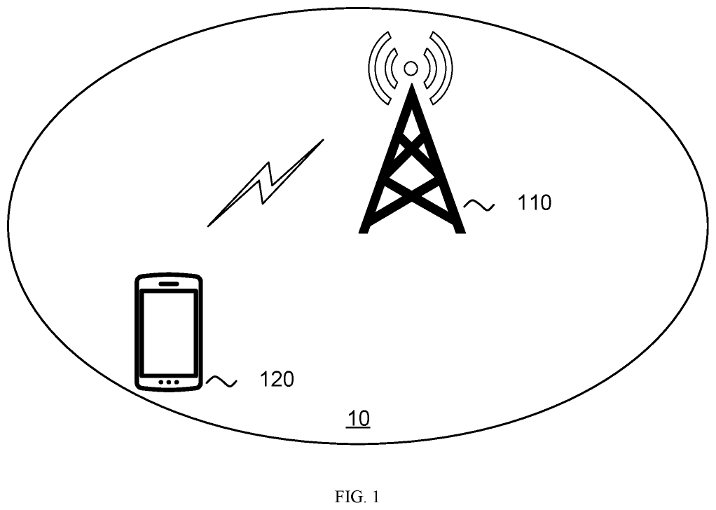

As illustrated in FIG. 1, the wireless communication system 10 may include a network device 110 and a terminal 120. The network device 110 may be a device for communicating with the terminal 120. In addition, the network device 110 may provide communication coverage for a specific geographical area, and may communicate with the terminal(s) 120 within the coverage area.

Optionally, the wireless communication system 10 may include multiple network devices, and there may be some quantity of terminals in a coverage area of each of the network devices, which is not limited herein.

Optionally, the wireless communication system 10 may further include other network entities such as a network controller and a mobility management entity, which is not limited herein.

Optionally, in the wireless communication system 10, communication between the network device and the terminal and communication between the terminals each may be wireless communication or wired communication, which is not limited herein.

Related contents involved in technical solutions of embodiments of the disclosure will be introduced below.

### 1. Paging

In a paging procedure, the network device sends a paging message to the terminal at a specific time, to notify the terminal to perform corresponding operations or update related parameters. The terminal in an RRC_CONNECTED state can determine, by decoding the paging message, whether a current system message has changed. If the terminal detects that the system message has changed, the terminal will re-interpret the system message. The terminal in an RRC_IDLE state or in an RRC_INACTIVE state can know not only whether the current system message has changed, but also whether there is currently an incoming call request. Once an incoming call is detected, the terminal will trigger a random access procedure.

When the terminal is in an RRC_IDLE state, an RRC_INACTIVE state, or an RRC_CONNECTED state, the terminal can also determine, according to the paging message, whether to receive an earthquake and tsunami warning system (ETWS) notification or a commercial mobile alert system (CMAS) notification, if the terminal supports such capability.

As can be seen, the paging message has the following functions: (1) sending an incoming call request to the terminal in an RRC_IDLE state; (2) notifying the terminal in an RRC_IDLE state, in an RRC_INACTIVE state, or in an RRC_CONNECTED state that system information has changed; (3) instructing the terminal to start receiving an ETWS primary notification and/or an ETWS secondary notification; and instructing the terminal to start receiving a CMAS notification.

In addition, before monitoring the paging message, the terminal needs to complete time-frequency synchronization and automatic gain control (AGC) adjustment by using a reference signal (for example, a synchronization signal block (SSB)).

### 2. Paging Cycle, Paging Frame (PF), and Paging Occasion (PO)

The terminal in an RRC_IDLE state or in an RRC_INACTIVE state may use discontinuous reception (DRX) in order to reduce power consumption. A paging procedure supports DRX, and therefore, the paging cycle may also be referred to as a DRX cycle.

A DRX cycle may have at least one PF, and each PF may correspond to at least one PO. A PF may be a radio frame or a system frame. A PO can include multiple physical downlink control channel (PDCCH) monitoring occasions, and can consist of multiple subframes, multiple time slots (also referred to as “slots”), or multiple orthogonal frequency division multiplexing (OFDM) symbols.

In short, the terminal can monitor one PO per paging cycle (or DRX cycle) in order to monitor whether there is paging downlink control information (paging DCI), a paging message, etc.

### 3. Wake-Up Signal (WUS)

In some wireless communication networks (such as IoT), the probability that a network pages the terminal is low, and as a result, the terminal does not have to monitor paging DCI at a PO(s) in some DRX cycle(s). Therefore, in order to further reduce power consumption of the terminal, a WUS mechanism is introduced in a standard protocol formulated by the 3^{rd} generation partnership project (3GPP).

If the terminal is in an RRC_IDLE state or an RRC_INACTIVE state, the network device may send a WUS to the terminal before the terminal monitors a PO, and then the terminal may determine, according to an indication of the WUS, whether to monitor a PO corresponding to the WUS, which can prevent the terminal from always monitoring a PO in a paging cycle, thereby reducing power consumption of the terminal.

### 4. Paging Early Indication (PEI)

In order to reduce power consumption of the terminal, in a DRX scenario, each PO is associated with one PEI. Before monitoring a PO, the terminal needs to receive a PEI to determine whether to monitor a PO associated with the PEI, thereby reducing power consumption. The PEI may be DCI, a sequence, or the like.

In addition, in an extended idle mode DRX (eDRX) scenario, each eDRX cycle has a paging time window (PTW). The terminal monitors a paging PDCCH with a DRX cycle (the DRX cycle is short, and it can be considered that the terminal does not sleep and can always be reached) within a PTW so as to receive downlink data, while the terminal is in a sleep state for the rest of the time. In an eDRX scenario, one PEI may be associated with (or correspond to) multiple POs (supposing m POs). If a PEI is monitored by the terminal, the terminal determines, according to an indication of the PEI, whether to monitor m POs associated with the PEI.

The PEI may carry subgrouping information, where the subgrouping information may indicate which terminal subgroups are to be woken up (terminals associated with the same PO can be divided into multiple terminal subgroups).

As can be seen, the WUS may indicate whether the terminal needs to monitor a PO corresponding to the WUS, so as to reduce power consumption of the terminal. In addition, by monitoring a PO, the terminal can monitor paging DCI, receive a paging message, etc. With continuous evolution of standard protocols formulated by 3GPP and continuous increase in complexity of communication scenarios, to prolong the battery life of the terminal to a duration of several weeks or even several years, 3GPP is currently discussing issues related to introducing a new WUS (for example, a low-power WUS), as well as scenarios of using the new WUS to wake up the terminal in a non-RRC_IDLE state or in a non-RRC_INACTIVE state so as to reduce power consumption. To this end, the problem regarding a function of the new WUS and how to use together with an existing WUS to further reduce power consumption of the terminal needs further study.

The disclosure provides a monitoring method and apparatus, a terminal, and a network device, so as to realize monitoring of a first paging downlink control information (DCI) or a second wake-up signal (WUS) based on a first timer once a first WUS is received, thereby ensuring robustness and stability of system communication while reducing network overhead and power consumption of a terminal.

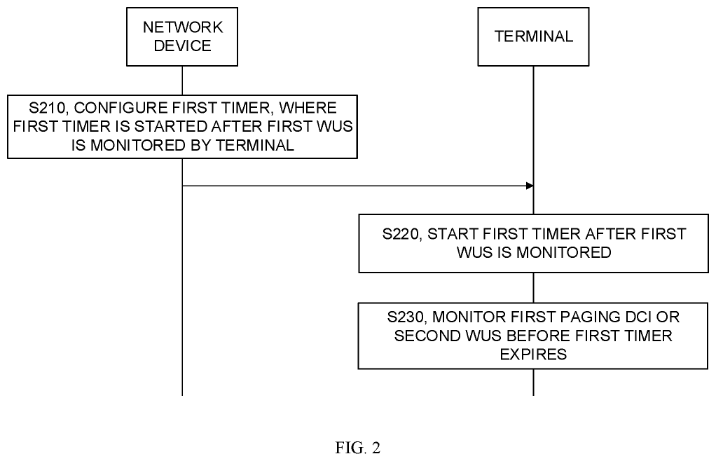

With reference to the foregoing elaborations, embodiments of the disclosure provide a monitoring method. As illustrated in FIG. 2, the method includes the following.

S210, a network device configures a first timer, where the first timer is started after a first WUS is monitored by a terminal.

Exemplarily, the first WUS may be used for triggering start of the first timer by the terminal.

Exemplarily, the first WUS may include a low-power WUS.

Exemplarily, a duration of the first timer may represent a duration for the terminal to monitor a first paging DCI or a second WUS.

Exemplarily, the first paging DCI may be used for scheduling a paging message.

Exemplarily, the second WUS may be used for triggering start of a second timer by the terminal. In addition, the second WUS may indicate whether the terminal is to start the second timer.

It should be noted that, the second WUS in the disclosure may include bit information, and there is a correspondence between a bit in the bit information and the terminal. Therefore, in the disclosure, whether to start the second timer may be determined according to a value of a bit corresponding to the terminal in the bit information. For example, if the value of the bit corresponding to the terminal in the bit information is “1”, it indicates that the terminal is to start the second timer; if the value of the bit corresponding to the terminal in the bit information is “0”, it indicates that the terminal is not to start the second timer, and vice versa.

Exemplarily, a duration of the second timer may represent a duration for the terminal to monitor a second paging DCI.

Exemplarily, the second paging DCI may be used for scheduling a paging message.

S220, the terminal starts the first timer after the first WUS is monitored. The first timer is started once the first WUS is monitored.

S230, the terminal monitors the first paging DCI or the second WUS before the first timer expires.

As can be seen, the terminal starts the first timer after the first WUS is monitored, and the terminal monitors the first paging DCI or the second WUS before the first timer expires. The first WUS is used for triggering start of the first timer by the terminal, the second WUS is used for triggering start of the second timer by the terminal, and the duration of the second timer represents the duration for the terminal to monitor the second paging DCI. Therefore, after the first WUS is received, the first paging DCI or the second WUS can be monitored based on the first timer, thereby ensuring robustness and stability of system communication while reducing network overhead and power consumption of the terminal.

It should be noted that, in a standard protocol formulated by 3GPP, a WUS mechanism is introduced, and a WUS can indicate whether the terminal in an RRC_IDLE state or in an RRC_INACTIVE state needs to monitor a PO corresponding to the WUS, so as to reduce power consumption. In addition, by monitoring a PO, the terminal can monitor paging DCI, receive a paging message, etc. However, with continuous evolution of standard protocols formulated by 3GPP and continuous increase in complexity of communication scenarios, in a future standard protocol, a new WUS mechanism different from the foregoing WUS mechanism needs to be introduced to monitor related signals.

To this end, a new WUS mechanism is considered in the disclosure. That is, the first WUS is used for triggering start of the first timer by the terminal, and the terminal monitors the first paging DCI or the second WUS before the first timer expires. In this way, it is possible to monitor the first paging DCI or the second WUS based on the first timer, thereby ensuring robustness and stability of system communication while reducing network overhead and power consumption of the terminal.

With reference to the foregoing elaborations, technical solutions involved in the foregoing method will be elaborated below in embodiments of the disclosure.

Specifically, the duration of the first timer or the duration of the second timer is pre-configured. Alternatively, the duration of the first timer or the duration of the second timer is specified in a protocol. Alternatively, the duration of the first timer or the duration of the second timer is configured by a network. Alternatively, the duration of the first timer or the duration of the second timer is determined according to first interval length information and duration ratio coefficient information configured by the network, where the first interval length information indicates a time interval between when the first WUS is currently monitored by the terminal and when the first WUS is monitored last time by the terminal.

The duration of the first timer or the duration of the second timer may be in units of: paging cycles, DRX cycles, milliseconds, system frames, seconds, subframes, time slots, or OFDM symbols. For example, the duration of the first timer or the duration of the second timer is two paging cycles.

It should be noted that, in the disclosure, the duration of the first timer or the duration of the second timer may be configured in different manners, such as pre-configuration, explicit configuration by the network, configuration based on the first interval length information and the duration ratio coefficient information configured by the network, which is conducive to flexibility and diversity in configuring the first timer or the second timer.

In addition, the duration of the first timer or the duration of the second timer may be a product of the first interval length information and the duration ratio coefficient information.

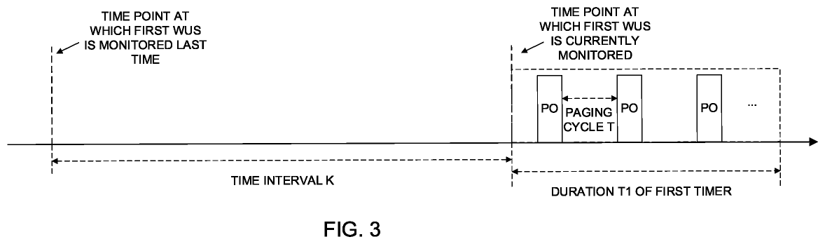

For example, the network may configure a duration coefficient X (represented by the duration ratio coefficient information) for the terminal by system information, where the value of X may be ⅛, 1/16, 1/32, or the like. If the first WUS is currently monitored by the terminal, the terminal determines the duration T1 of the first timer currently started according to the duration coefficient X and a time interval K (represented by the first interval length information) between when the first WUS is currently monitored and when the first WUS is received last time, that is, T1=X*K, where the value of T1 and the value of K each may be in units of paging cycles, milliseconds, system frames, seconds, subframes, time slots, OFDM symbols, or the like. As illustrated in FIG. 3, the duration T1 of the first timer may include multiple paging cycles T.

Specifically, in the disclosure, the following may be further included. The network device sends the first WUS, where the first WUS is used for triggering start of the first timer by the terminal.

The first WUS may be used for triggering transition of the terminal to a second state from a first state.

It should be noted that, in addition to triggering start of the first timer by the terminal, the first WUS in the disclosure can also be used for triggering transition of the terminal to the second state from the first state. In this case, if the first WUS is monitored by the terminal in the first state, the terminal transitions to the second state from the first state, and starts the first timer in the second state.

The first state may indicate that the terminal is in a first operating state, and the second state may indicate that the terminal is in a second operating state, where the first operating state is different from the second operating state.

In addition, the terminal in the first operating state (or the first state) may be unable to perform normal communication operations or update related parameters. For example, the terminal is unable to monitor a WUS (the WUS is different from the first WUS, and indicates whether the terminal is to monitor a corresponding/associated PO)/paging DCI/PEI information, receive a system message, or transmit related data, etc., but can monitor the first WUS. The terminal in the second operating state (or the second state) can perform normal communication operations or update related parameters.

The first state (or the first operating state) may include a deep sleep state, a power-off state, or a flight mode. The second state (or the second operating state) may include an RRC idle state, an RRC inactive state, or an RRC connected state.

It should be noted that, if the terminal is in the deep sleep state, the network device may send the first WUS to trigger transition of the terminal to the RRC_IDLE/RRC_INACTIVE/RRC_CONNECTED state from the deep sleep state, that is, the terminal determines, according to the first WUS, that the terminal needs to leave the deep sleep mode and enter an active mode. Compared with the RRC_IDLE/RRC_INACTIVE/RRC_CONNECTED state, power consumption of the terminal is lower in the deep sleep state.

If the terminal is in the power-off state or the flight mode, the network device may send the first WUS to trigger transition of the terminal the RRC_IDLE/RRC_INACTIVE/RRC_CONNECTED state from the power-off state/the flight mode, that is, the terminal determines, according to the first WUS, that the terminal needs to be powered on or leave the flight mode so as to enter an active mode.

In addition, since the terminal is generally unable to receive any signal in the power-off state/the flight mode, in order to ensure that the first WUS can be monitored by the terminal in the power-off state/the flight mode, the terminal in the disclosure may include a primary communication module and a secondary communication module. If the terminal is in the power-off state/the flight mode, the primary communication module of the terminal is in an off-state, while the secondary communication module is in an on-state so as to monitor the first WUS. If the first WUS is monitored by the secondary communication module of the terminal, the terminal enables the primary communication module, that is, the terminal transitions to the RRC_IDLE/RRC_INACTIVE state from the power-off state/the flight mode, and performs corresponding communication operations (for example, monitor a WUS (the WUS indicates whether the terminal is to monitor a corresponding PO, and is different from the first WUS), monitor paging DCI, monitor PEI information, receive a system message, or transmit related data, etc.) or updates related parameters with the primary communication module.

In addition, if the terminal is in the deep sleep state, the terminal may include a primary communication module, and monitors the first WUS with the primary communication module. Alternatively, the terminal may include a primary communication module and a secondary communication module, and monitors the first WUS with the secondary communication module, the details thereof are the same as the foregoing elaborations and will not be elaborated again herein.

Specifically, power consumption of the terminal in the first state is lower than power consumption of the terminal in the second state.

It should be noted that, the terminal in the first state is generally unable to perform corresponding communication operations (for example, monitor a WUS/paging DCI/PEI information, receive a system message, transmit related data, etc.) or update related parameters, while the terminal in the second state can perform the foregoing operations. Therefore, compared with the second state, power consumption of the terminal is lower in the first state. In order to ensure communication functions of the terminal, in the disclosure, a low-power WUS (namely, the first WUS) is needed to trigger transition of the terminal to the second state from the first state, which can realize state transition by transmitting the first WUS, thereby ensuring robustness and stability of system communication while reducing network overhead and power consumption of the terminal.

With reference to the foregoing elaborations, the technical solutions involved in the disclosure will be further described below.

Specifically, in the disclosure, the following may be further included. The network device sends configuration information.

The configuration information may be used for determining a first resource location, and the first resource location may be used for monitoring the first paging DCI or the second WUS.

Specifically, before monitoring the first paging DCI or the second WUS in S230, the method may further include the following. Obtain the configuration information. The terminal determines the first resource location according to the configuration information before the first timer expires, where the first resource location is used for monitoring the first paging DCI or the second WUS.

It should be noted that, in order to determine a resource location (the first resource location) used for monitoring the first paging DCI or the second WUS, in the disclosure, the network device sends the configuration information, and then the terminal determines the first resource location according to the configuration information, which is possible to determine, based on the configuration information, the resource location used for monitoring the first paging DCI or the second WUS, thereby ensuring robustness and stability of system communication.

The configuration information may be carried in a system message, or the configuration information may be configured by an RRC layer or an upper layer.

It can be understood that, in the disclosure, the resource location used for monitoring the first paging DCI or the second WUS may be configured by the configuration information in a system broadcast message, or the resource location used for monitoring the first paging DCI or the second WUS may be configured by RRC or an upper layer.

The configuration information may include paging configuration parameter information or wake-up configuration parameter information. The paging configuration parameter information may be used for configuring a PO. The wake-up configuration parameter information may be used for configuring the first resource location.

It should be noted that, the configuration information in the disclosure may include the paging configuration parameter information. In some embodiments, the paging configuration parameter information may include a higher-layer parameter DownlinkConfigCommonSIB. The higher-layer parameter DownlinkConfigCommonSIB may be used for providing common downlink parameters of a cell. The higher-layer parameter DownlinkConfigCommonSIB includes a higher-layer parameter PCCH-Config. The higher-layer parameter PCCH-Config may be used for configuring a paging procedure. As such, it is possible to determine, based on the paging configuration parameter information, the resource location used for monitoring the first paging DCI or the second WUS, thereby ensuring robustness and stability of system communication while reducing network overhead and power consumption of the terminal.

Exemplarily, the higher-layer parameter PCCH-Config includes the following parameters:

| | |
|---|---|
| PCCH-Config ::= | SEQUENCE { |
| defaultPagingCycle | PagingCycle, |
| nAndPagingFrameOffset | CHOICE { |
| oneT | NULL, |
| halfT | INTEGER (0..1), |
| quarterT | INTEGER (0..3), |
| oneEighthT | INTEGER (0..7), |
| oneSixteenthT | INTEGER (0..15), |

},

| | |
|---|---|
| ns | ENUMERATED {four, two, one}, |

```
    firstPDCCH-MonitoringOccasionOfPO CHOICE {
  sC15KHZoneT SEQUENCE (SIZE (1..maxPO-perPF)) OF INTEGER (0..139),
```

| | |
|---|---|
| sCS30KHZoneT-SCS15KHZhalfT | SEQUENCE (SIZE (1..maxPO-perPF)) OF |

INTEGER (0..279),

| | |
|---|---|
| sCS60KHZoneT-SCS30KHZhalfT-SCS15KHZquarterT | SEQUENCE (SIZE |

```
(1..maxPO-perPF)) OF INTEGER (0..559),
      sCS120KHZoneT-SCS60KHZhalfT-SCS30KHZquarterT-SCS15KHZoneEigthT
SEQUENCE (SIZE (1..maxPOP-perPF)) OF INTEGER (0..1119),
      sCS120KHZhalfT-SCS60KHZquarterT-SCS30KHZoneEigthT-
SCS15KHZoneSixthT SEQUENCE (SIZE (1..maxPO-perPF)) OF INTEGER (0..2239),
      sCS120KHZquarterT-SCS60KHZoneEighthT-SCS30KHZoneSixteenthT
SEQUENCE (SIZE (1..maxPO-perPF)) OF INTEGER (0..479),
```

| | |
|---|---|
| sCS120KHZoneEighthT-SCS60KHZoneSixteenthT | SEQUENCE (SIZE |

(1..maxPO-perPF)) OF INTEGER (0..8959),

| | |
|---|---|
| sCS120KHZoneSixteenthT | SEQUENCE (SIZE (1..maxPO-perPF)) |

```
OF INTEGER (0..17919)
    } OPTIONAL,
    ...,
    [[
    nrofPDCCH-MonitoringOccasionPerSSB-InPO-r16 INTEGER (2..4) OPTIONAL
    ]]
  }
```

The higher-layer parameter defaultPagingCycle may be used for configuring a default paging cycle (or DRX cycle).

The higher-layer parameter nAndPagingFrameOffset may be used for configuring the total number of PFs and a PF offset in a paging cycle (or DRX cycle). oneT represents that a paging cycle has one PF, halfT represents that a paging cycle has two PFs, and so forth. INTEGER (0 . . . 1) indicates a PF offset between two PFs, and so forth.

The higher-layer parameter ns can be used for configuring the total number of POs corresponding to a PF. For example, one PF may correspond to one PO, two POs, or four POs, etc.

The higher-layer parameter firstPDCCH-MonitoringOccasionOfPO may be used for configuring a location of a starting PDCCH monitoring occasion for each PO corresponding to a PF. One PO consists of multiple consecutive PDCCH monitoring occasions.

In addition, the configuration information in the disclosure may include the wake-up configuration parameter information, where the wake-up configuration parameter information may be used for configuring the first resource location. It may be understood that, the network may send separately the configuration information (namely, the wake-up configuration parameter information) used for configuring the first WUS. As such, the resource location used for monitoring the first paging DCI or the second WUS can be determined based on the wake-up configuration parameter information, thereby ensuring robustness and stability of system communication while reducing network overhead and power consumption of the terminal.

With reference to the foregoing elaborations, the following will describe in detail how to determine the first resource location according to the configuration information.

### Manner 1

Specifically, if the configuration information includes the paging configuration parameter information, the first resource location may be determined according to the configuration information as follows. The terminal determines at least one first PO according to the paging configuration parameter and device identity (ID) information of the terminal, and takes the at least one first PO as the first resource location.

It should be noted that, a PF or PO used for paging may be determined according to the following formula:

$$( SFN + PF\_offeset ) mod T = ( T div N ) * ( UE\_ID mod N ) ;$$

$$i\_s = floor ( UE\_ID / N ) Mod Ns$$

The SFN represents a system frame number of the PF.

T represents a paging cycle or a DRX cycle. The value of T may be determined according to the higher-layer parameter defaultPagingCycle. In addition, T=min(Tc, Tue), where Tc represents a specific DRX value (configured by RRC or an upper layer), and Tue represents a default DRX value broadcast in system information.

PF_offset represents an offset used for PF determination. The value of PF_offset may be determined according to the higher-layer parameter nAndPagingFrameOffset.

N represents the total number of PFs in a paging cycle or DRX cycle. The value of N may be determined according to the higher-layer parameter nAndPagingFrameOffset.

i_s represents an index of a PO corresponding to a PF, that is, i_s indicates that the terminal is to monitor an (i_s+1)^{th} PO in the PF.

Ns represents the total number of POs corresponding to a PF. The value of Ns may be determined according to the higher-layer parameter ns.

UE_ID represents the device ID information of the terminal. The value of UE_ID may be determined according to: 5^{th} generation system architecture evolution temporary mobile subscriber identity (5G-S-TMSI) mod 1024, where TMSI represents a temporary mobile subscriber identity of the terminal, and may be used for uniquely differentiating different terminals. If the terminal does not have a TMSI, UE_ID=0 by default.

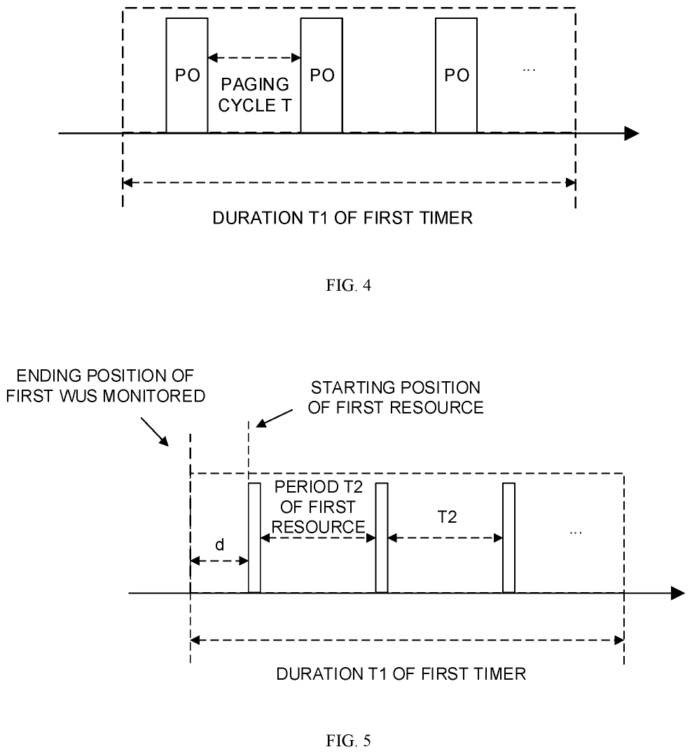

Exemplarily, as illustrated in FIG. 4, the duration of the first timer is T1. Before the first timer expires, the terminal determines multiple POs according to the paging configuration parameter and the device ID information of the terminal, where a time interval between the POs is paging cycle T; and then the terminal monitors the first paging DCI or the second WUS at the multiple POs determined.

As can be seen, the paging configuration parameter in the disclosure may include T, PF_offset, N, and/or Ns. In this way, before the first timer expires, the terminal can determine at least one PO (such as i_s of the first PO) according to the paging configuration parameter (such as T, PF_offset, N, and Ns) and the device ID information (such as UE_ID) of the terminal, and takes the at least one determined PO as the resource location used for monitoring the first paging DCI or the second WUS, that is, the terminal monitors the first paging DCI or the second WUS at the at least one PO determined. As such, it is possible to determine, based on the paging configuration parameter, the resource location used for monitoring the first paging DCI or the second WUS, thereby ensuring robustness and stability of system communication while reducing network overhead and power consumption of the terminal.

### Manner 2

Specifically, the wake-up configuration parameter information may include at least one of: offset information or period information. The offset information is used for configuring an offset from an ending position of the first WUS to a starting position of the first resource location. The period information is used for configuring a period of the first resource location.

It should be noted that, with reference to the foregoing illustrations, the network may send separately the wake-up configuration parameter information used for configuring the first resource location. The starting position of the first resource location is configured by the offset information in the wake-up configuration parameter information, and the period of the first resource location is configured by the period information in the wake-up configuration parameter information. As such, the resource location used for monitoring the first paging DCI or the second WUS can be determined based on the offset information and the period information, thereby ensuring robustness and stability of system communication while reducing network overhead and power consumption of the terminal.

As can be seen, if the configuration information includes the wake-up configuration parameter information, the first resource location may be determined according to the configuration information as follows. The terminal determines the first resource location according to the wake-up configuration parameter information.

The wake-up configuration parameter information may include the offset information and the period information. Therefore, the network may send separately the wake-up configuration parameter information, so as to realize determination of the resource location used for monitoring the first paging DCI or the second WUS, thereby ensuring robustness and stability of system communication while reducing network overhead and power consumption of the terminal.

Exemplarily, as illustrated in FIG. 5, the duration of the first timer is T1. Before the first timer expires, the terminal determines the first resource location according to the offset information and the period information, where the offset information is used for configuring the offset from the ending position of the first WUS to the starting position of the first resource location as d, and the period information is used for configuring the period of the first resource location as T2; and accordingly, a time interval between the first resource locations is period T2, and the terminal monitors the first paging DCI or the second WUS at the first resource locations.

With reference to the foregoing elaborations, the technical solutions involved in the disclosure will be further described below for the case where the first timer expires and with regard to whether the first paging DCI is monitored by the terminal.

Specifically, if the first timer expires and the second WUS is monitored by the terminal, the terminal starts the second timer according to the second WUS. Alternatively, if the first timer expires and the second WUS is not monitored by the terminal, the terminal starts the second timer by default. Alternatively, if the first timer expires and the second WUS is not monitored by the terminal, the terminal does not start the second timer by default.

It should be noted that, after the first WUS is monitored, the terminal starts the first timer, and then the terminal monitors the second WUS before the first timer expires.

The second WUS in the disclosure may indicate whether the terminal is to start the second timer. Exemplarily, the second WUS may include bit information, and there is a correspondence between a bit in the bit information and the terminal. Therefore, in the disclosure, whether to start the second timer may be determined according to a value of a bit corresponding to the terminal in the bit information. For example, if the value of the bit corresponding to the terminal in the bit information is “1”, it indicates that the terminal is to start the second timer; if the value of the bit corresponding to the terminal in the bit information is “0”, it indicates that the terminal is not to start the second timer, and vice versa.

Based on this, if the first timer expires and the second WUS is monitored by the terminal, the terminal starts the second timer according to the second WUS, so as to monitor the second paging DCI before the second timer expires, which is possible to realize monitoring of the second paging DCI based on the second timer, thereby ensuring robustness and stability of system communication while reducing network overhead and power consumption of the terminal.

In addition, if the first timer expires and the second WUS is not monitored by the terminal, the terminal in the disclosure may start the second timer by default, or may not start the second timer by default, which depends on a configuration of the network or is determined by the terminal according to protocol specification.

Exemplarily, the network may send configuration information to the terminal, where the configuration information may include the bit information. Therefore, in the disclosure, whether to start the second timer by default or not to start the second timer by default can be determined according to a value of a bit in the bit information. If the value of the bit in the bit information is “1”, the terminal starts the second timer by default on condition that the first timer expires and the second WUS is not monitored by the terminal; if the value of the bit in the bit information is “0”, the terminal does not start the second timer by default on condition that the first timer expires and the second WUS is not monitored by the terminal, and vice versa.

Similarly, if it is specified in a protocol that the terminal starts the second timer by default, the terminal starts the second timer by default on condition that the first timer expires and the second WUS is not monitored by the terminal. If it is specified in a protocol that the terminal does not start the second timer by default, the terminal does not start the second timer by default on condition that the first timer expires and the second WUS is not monitored by the terminal.

Based on this, if the first timer expires and the second WUS is not monitored by the terminal, the terminal starts the second timer by default. If the terminal starts the second timer by default, the terminal monitors the second paging DCI before the second timer expires, which can realize monitoring of the second paging DCI based on the second timer, thereby ensuring robustness and stability of system communication while reducing network overhead and power consumption of the terminal.

If the first timer expires and the second WUS is not monitored by the terminal, the terminal does not start the second timer by default. If the terminal does not start the second timer by default, the terminal may transition to the first state from the second state, which is beneficial to reducing power consumption.

The method may further include the following. If the second timer is started by the terminal and the configuration information includes the paging configuration parameter information, the terminal determines at least one second PO according to the paging configuration parameter information and the device ID information of the terminal before the second timer expires. Monitor the second paging DCI at the at least one second PO.

It should be noted that, the paging configuration parameter in the disclosure may include T, PF_offset, N, and/or Ns. In this way, before the second timer expires, the terminal may determine at least one PO (e.g. i_s of the second PO) according to the paging configuration parameter (such as T, PF_offset, N, and Ns) and the device ID information (such as UE_ID) of the terminal, and takes the at least one determined PO as a resource location used for monitoring the second paging DCI, that is, the terminal monitors the second paging DCI at the at least one determined PO, which is possible to realize monitoring of the second paging DCI based on the paging configuration parameter information before the second timer expires, thereby ensuring robustness and stability of system communication while reducing network overhead and power consumption of the terminal.

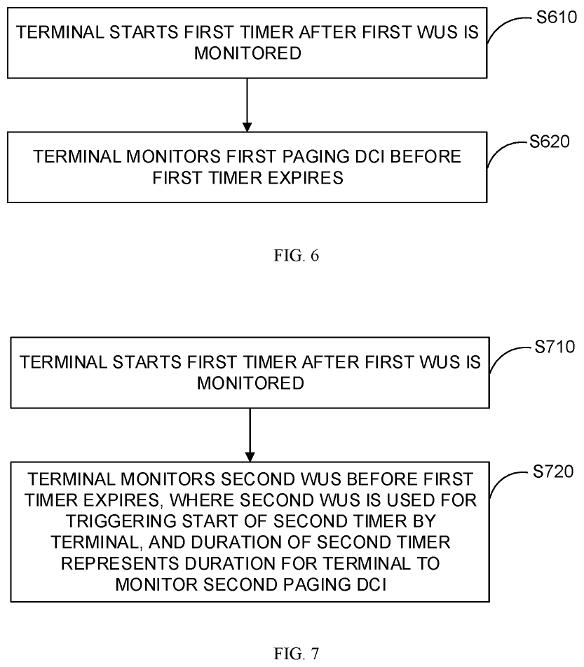

With reference to the foregoing elaborations, embodiments of the disclosure provide another monitoring method. As illustrated in FIG. 6, the method includes the following.

S610, a terminal starts a first timer after a first WUS is monitored.

The first WUS may be used for triggering start of the first timer by the terminal.

The first WUS may include a low-power WUS.

A duration of the first timer may represent a duration for the terminal to monitor a first paging DCI.

S620, the terminal monitors the first paging DCI before the first timer expires.

The first paging DCI may be used for scheduling a paging message.

Specifically, the duration of the first timer is pre-configured. Alternatively, the duration of the first timer is configured by a network. Alternatively, the duration of the first timer is determined according to first interval length information and duration ratio coefficient information configured by the network, where the first interval length information indicates a time interval between when the first WUS is currently monitored by the terminal and when the first WUS is monitored last time by the terminal.

Specifically, the first WUS is used for triggering transition of the terminal to a second state from a first state.

The first state includes a deep sleep state, a power-off state, or a flight mode. The second state includes an RRC idle state, an RRC inactive state, or an RRC connected state.

Power consumption of the terminal in the first state is lower than power consumption of the terminal in the second state.

Specifically, before monitoring the first paging DCI, the method may further include the following. The terminal obtains configuration information. Before the first timer expires, the terminal determines a first resource location according to the configuration information, where the first resource location is used for monitoring the first paging DCI.

The configuration information is carried in a system message, or the configuration information is configured by an RRC layer or an upper layer.

The configuration information includes paging configuration parameter information or wake-up configuration parameter information. The paging configuration parameter information may be used for configuring a PO. The wake-up configuration parameter information may be used for configuring the first resource location.

In addition, if the configuration information includes the paging configuration parameter information, the first resource location may be determined according to the configuration information as follows. The terminal determines at least one first PO according to the paging configuration parameter and device ID information of the terminal, and takes the at least one first PO as the first resource location.

In addition, the wake-up configuration parameter information includes at least one of: offset information or period information. The offset information is used for configuring an offset from an ending position of the first WUS to a starting position of the first resource location. The period information is used for configuring a period of the first resource location.

It should be noted that, for the implementation of each operation in the embodiments illustrated in FIG. 6, reference can be made to the elaborations in the method embodiments illustrated in FIG. 2, which will not be described again herein.

With reference to the foregoing elaborations, embodiments of the disclosure provide another monitoring method. As illustrated in FIG. 7, the method includes the following.

S710, a terminal starts a first timer after a first WUS is monitored.

Exemplarily, the first WUS may be used for triggering start of the first timer by the terminal.

Exemplarily, the first WUS may include a low-power WUS.

Exemplarily, a duration of the first timer may represent a duration for the terminal to monitor a second WUS.

S720, the terminal monitors the second WUS before the first timer expires, where the second WUS is used for triggering start of a second timer by the terminal, and a duration of the second timer represents a duration for the terminal to monitor a second paging DCI.

Exemplarily, the second paging DCI may be used for scheduling a paging message.

Specifically, the second WUS may indicate whether the terminal is to start the second timer.

It should be noted that, the second WUS in the disclosure may include bit information, and there is a correspondence between a bit in the bit information and the terminal. Therefore, in the disclosure, whether to start the second timer may be determined according to a value of a bit corresponding to the terminal in the bit information. For example, if the value of the bit corresponding to the terminal in the bit information is “1”, it indicates that the terminal is to start the second timer; if the value of the bit corresponding to the terminal in the bit information is “0”, it indicates that the terminal is not to start the second timer, and vice versa.

Specifically, the duration of the first timer or the duration of the second timer is pre-configured. Alternatively, the duration of the first timer or the duration of the second timer is configured by a network. Alternatively, the duration of the first timer or the duration of the second timer is determined according to first interval length information and duration ratio coefficient information configured by the network, where the first interval length information indicates a time interval between when the first WUS is currently monitored by the terminal and when the first WUS is monitored last time by the terminal.

Specifically, the first WUS is used for triggering transition of the terminal to a second state from a first state.

The first state includes a deep sleep state, a power-off state, or a flight mode. The second state includes an RRC idle state, an RRC inactive state, or an RRC connected state.

Power consumption of the terminal in the first state is lower than power consumption of the terminal in the second state.

Specifically, before monitoring the second WUS, the method may further include the following. The terminal obtains configuration information. Before the first timer expires, the terminal determines a first resource location according to the configuration information, where the first resource location is used for monitoring the second WUS.

The configuration information is carried in a system message, or the configuration information is configured by an RRC layer or an upper layer.

The configuration information includes paging configuration parameter information or wake-up configuration parameter information. The paging configuration parameter information may be used for configuring a PO. The wake-up configuration parameter information may be used for configuring the first resource location.

In addition, if the configuration information includes the paging configuration parameter information, the first resource location may be determined according to the configuration as follows. The terminal determines at least one first PO according to the paging configuration parameter and device ID information of the terminal, and takes the at least one first PO as the first resource location.

In addition, the wake-up configuration parameter information includes at least one of: offset information or period information. The offset information is used for configuring an offset from an ending position of the first WUS to a starting position of the first resource location. The period information is used for configuring a period of the first resource location.

Specifically, after monitoring the second WUS, the method may further include the following. If the first timer expires and the second WUS is monitored by the terminal, the terminal starts the second timer according to the second WUS. Alternatively, if the first timer expires and the second WUS is not monitored by the terminal, the terminal starts the second timer by default. Alternatively, if the first timer expires and the second WUS is not monitored by the terminal, the terminal does not start the second timer by default.

In addition, the method may further include the following. If the second timer is started by the terminal and the configuration information includes the paging configuration parameter information, the terminal determines at least one second PO according to the paging configuration parameter information and the device ID information of the terminal before the second timer expires. Monitor the second paging DCI at the at least one second PO.

It should be noted that, for the implementation of each operation in the embodiments illustrated in FIG. 7, reference can be made to the elaborations in the method embodiments illustrated in FIG. 2, which will not be described again herein.

The solutions in embodiments of the disclosure are introduced mainly from the perspective of method. It can be understood that, in order to implement the foregoing functions, the terminal or the network device includes corresponding hardware structures and/or software modules for executing respective functions. Those of ordinary skill in the art will appreciate that units and algorithmic operations of various examples described in connection with embodiments herein may be implemented by hardware or by a combination of hardware and computer software. Whether these functions are performed by means of hardware or hardware driven by computer software depends on the application and the design constraints of the associated technical solution. Those skilled in the art may use different methods with regard to each particular application to implement the described functionality, but such methods should not be regarded as lying beyond the scope of the disclosure.

In embodiments of the disclosure, division of functional units of the terminal or the network device may be implemented according to the foregoing method examples. For example, functional units may be divided to correspond to respective functions, or two or more functions may be integrated into one processing unit. The integrated unit may be implemented in a form of hardware, or may be implemented in a form of software program module. It should be noted that, the division of units in embodiments of the disclosure is illustrative and is only a division of logical functions, and other manners of division may also available in practice.

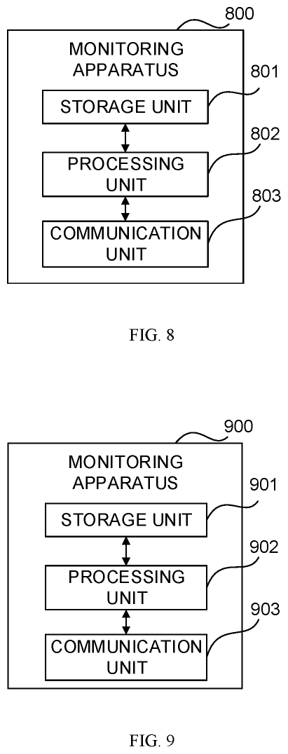

If an integrated unit is adopted, FIG. 8 is a block diagram illustrating functional units of a monitoring apparatus. The apparatus 800 for determining a resource location includes a processing unit 802 and a communication unit 803. The processing unit 802 is configured to control and manage actions of the apparatus 800. For example, the processing unit 802 is configured to support the apparatus 800 to implement the steps performed by the terminal in FIG. 2, as well as other procedures in the technical solutions described in the disclosure. The communication unit 803 is configured to support communication between the apparatus 800 and other devices in a wireless communication system. The apparatus 800 may further include a storage unit 801. The storage unit 801 is configured to store program codes executed by the apparatus 800 and data to be transmitted by the apparatus 800.

It should be noted that, the apparatus 800 may be a chip or a chip module.

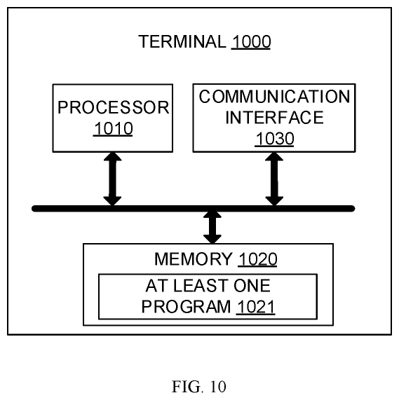

The processing unit 802 may be a processor or a controller and may be, for example, a central processing unit (CPU), a general-purpose processor, a digital signal processor (DSP), an application-specific integrated circuit (ASIC), a field programmable gate array (FPGA), or other programmable logic devices, transistor logic devices, hardware components, or any combination thereof. Various exemplary logic blocks, modules, and circuits disclosed in the disclosure can be implemented or executed. The processing unit 802 may also be a combination for implementing computing functions, for example, one or more microprocessors, a combination of DSP and microprocessor, or the like. The communication unit 803 may be a communication interface, a transceiver, a transceiver circuit, or the like, and the storage unit 801 may be a memory. If the processing unit 802 is a processor, the communication unit 803 is a communication interface, and the storage unit 801 is a memory, the apparatus 800 involved in embodiments of the disclosure may be a terminal illustrated in FIG. 10.

In an implementation, the processing unit 802 is configured to perform any step executed by the terminal in the foregoing method embodiments, and when performing data transmission such as sending, the processing unit 802 may optionally invoke the communication unit 803 to complete corresponding operations. Detailed elaborations will be given below.

The processing unit 802 is configured to: start a first timer after a first WUS is monitored, and monitor a first paging DCI or a second WUS before the first timer expires, where the second WUS is used for triggering start of a second timer of the apparatus 800, and a duration of the second timer represents a duration for the apparatus 800 to monitor a second paging DCI.

It should be noted that, for the implementation of each operation in the embodiments illustrated in FIG. 8, reference can be made to the illustrations in the method embodiments illustrated in FIG. 2, which will not be described again herein.

Specifically, a duration of the first timer or the duration of the second timer is pre-configured. Alternatively, the duration of the first timer or the duration of the second timer is configured by a network. Alternatively, the duration of the first timer or the duration of the second timer is determined according to first interval length information and duration ratio coefficient information configured by the network, where the first interval length information indicates a time interval between when the first WUS is currently monitored by a terminal and when the first WUS is monitored last time by the terminal.

Specifically, the first WUS is used for triggering transition of the apparatus to a second state from a first state.

Specifically, the first state includes a deep sleep state, a power-off state, or a flight mode. The second state includes an RRC idle state, an RRC inactive state, or an RRC connected state.

Specifically, power consumption of the apparatus in the first state is lower than power consumption of the apparatus in the second state.

Specifically, the processing unit 802 is further configured to operate as follows before monitoring the first paging DCI or the second WUS: obtain configuration information, and determine a first resource location according to the configuration information before the first timer expires, where the first resource location is used for monitoring the first paging DCI or the second WUS.

Specifically, the configuration information is carried in a system message, or the configuration information is configured by an RRC layer or an upper layer.

Specifically, the configuration information includes paging configuration parameter information or wake-up configuration parameter information. The paging configuration parameter information is used for configuring a PO. The wake-up configuration parameter information used for configuring a first resource location.

Specifically, the configuration information includes the paging configuration parameter information, and in terms of determining the first resource location according to the configuration information, the processing unit 802 is configured to determine at least one first PO according to the paging configuration parameter and device ID information, and take the at least one first PO as the first resource location.

Specifically, the wake-up configuration parameter information includes at least one of: offset information or period information. The offset information is used for configuring an offset from an ending position of the first WUS to a starting resource location of the first resource location. The period information is used for configuring a period of the first resource location.

Specifically, the processing unit 802 is further configured to: start the second timer according to the second WUS if the first timer expires and the second WUS is monitored; or start the second timer by default if the first timer expires and the second WUS is not monitored, or not start the second timer by default if the first timer expires and the second WUS is not monitored.

Specifically, the processing unit 802 is further configured to: determine at least one second PO according to the paging configuration parameter information and device ID information before the second timer expires if the second timer is started and the configuration information includes the paging configuration parameter information; and monitor the second paging DCI at the at least one second PO.

If an integrated unit is adopted, FIG. 9 is a block diagram illustrating functional units of another monitoring apparatus. The apparatus 900 includes a processing unit 902 and a communication unit 903. The processing unit 902 is configured to control and manage actions of the apparatus 900. For example, the processing unit 902 is configured to support the apparatus 900 to implement steps performed by the network device in FIG. 2, as well as other procedures in the technical solutions described in the disclosure. The communication unit 903 is configured to support communication between the apparatus 900 and other devices in a wireless communication system. The apparatus 900 may further include a storage unit 901. The storage unit 901 is configured to store program codes executed by the apparatus 900 and data to be transmitted by the apparatus 900.

It should be noted that, the apparatus 900 may be a chip or a chip module.

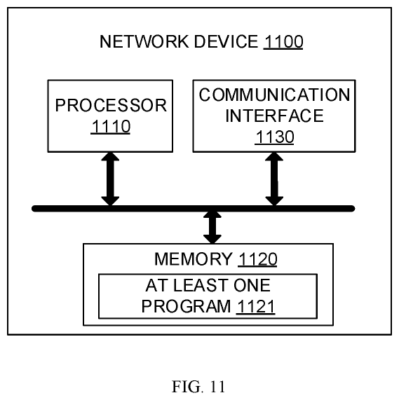

The processing unit 902 may be a processor or a controller, and may be, for example, a CPU, a DSP, an ASIC, an FPGA, or other programmable logic devices, transistor logic devices, hardware components, or any combination thereof. Various exemplary logic blocks, modules, and circuits disclosed in the disclosure can be implemented or executed. The processing unit 902 may also be a combination for implementing computing functions, for example, one or more microprocessors, a combination of DSP and microprocessor, or the like. The communication unit 903 may be a communication interface, a transceiver, a transceiver circuit, or the like, and the storage unit 901 may be a memory. If the processing unit 902 is a processor, the communication unit 903 is a communication interface, and the storage unit 901 is a memory, the apparatus 900 involved in embodiments of the disclosure may be a network device illustrated in FIG. 11.

In an implementation, the processing unit 902 is configured to perform any step executed by the network device in the foregoing method embodiments, and when performing data transmission such as sending, the processing unit 902 may optionally invoke the communication unit 903 to complete corresponding operations. Detailed elaborations will be given below.

The processing unit 902 is configured to configure a first timer, where the first timer is started after a first WUS is monitored by a terminal, a duration of the first timer represents a duration for the terminal to monitor a first paging DCI or a second WUS, the second WUS is used for triggering start of a second timer by the terminal, and a duration of the second timer represents a duration for the terminal to monitor a second paging DCI.

It should be noted that, for the implementation of each operation in the embodiments illustrated in FIG. 9, reference can be made to the elaborations in the method embodiments illustrated in FIG. 2, which will not be described again herein.

Specifically, the duration of the first timer or the duration of the second timer is pre-configured. Alternatively, the duration of the first timer or the duration of the second timer is configured by a network. Alternatively, the duration of the first timer or the duration of the second timer is determined according to first interval length information and duration ratio coefficient information configured by the network, where the first interval length information indicates a time interval between when the first WUS is currently monitored by the terminal and when the first WUS is monitored last time by the terminal.

Specifically, the processing unit 902 is further configured to send the first WUS, where the first WUS is used for triggering start of the first timer by the terminal.

Specifically, the first WUS is further used for triggering transition of the terminal to a second state from a first state.

Specifically, the first state includes a deep sleep state, a power-off state, or a flight mode. The second state includes an RRC idle state, an RRC inactive state, or an RRC connected state.

Specifically, the processing unit 902 is further configured to send configuration information, where the configuration information is used for determining a first resource location, and the first resource location is used for monitoring the first paging DCI or the second WUS.

Specifically, the configuration information is carried in a system message, or the configuration information is configured by an RRC layer or an upper layer.

Specifically, the configuration information includes paging configuration parameter information or wake-up configuration parameter information. The paging configuration parameter information is used for configuring a PO. The wake-up configuration parameter information is used for configuring the first resource location.

Specifically, the wake-up configuration parameter information includes at least one of: offset information or period information. The offset information is used for configuring an offset from an ending position of the first WUS and a starting position of the first resource location. The period information is used for configuring a period of the first resource location.

Referring to FIG. 10, FIG. 10 is a schematic structural diagram of a terminal provided in embodiments of the disclosure. The terminal 1000 includes a processor 1010, a memory 1020, a communication interface 1030, and a communication bus connecting the processor 1010, the memory 1020, and the communication interface 1030.

The memory 1020 includes, but is not limited to, a random access memory (RAM), a read-only memory (ROM), an erasable programmable ROM (EPROM), or a compact disc ROM (CD-ROM). The memory 1020 is configured to store program codes executed by the terminal 1000 and data to be transmitted by the terminal 1000.

The communication interface 1030 is configured to receive and transmit data.

The processor 1010 may be one or more CPUs. If the processor 1010 is a CPU, the CPU may be a single-core CPU or a multi-core CPU.

The processor 1010 of the terminal 1000 is configured to read at least one program 1021 stored in the memory 1020, to perform the following operations: starting a first timer after a first WUS is monitored; and monitoring a first paging DCI or a second WUS before the first timer expires, where the second WUS is used for triggering start of a second timer by the terminal 1000, and a duration of the second timer represents a duration for the terminal 1000 to monitor a second paging DCI.

It should be noted that, for the implementation of each operation, reference can be made to the corresponding elaboration in the method embodiments illustrated in FIG. 2. The terminal 1000 may be configured to perform the method at the terminal side in the foregoing method embodiments of the disclosure, which will not be described again herein.

Referring to FIG. 11, FIG. 11 is a schematic structural diagram of a network device provided in embodiments of the disclosure. The network device 1100 includes a processor 1110, a memory 1120, a communication interface 1130, and a communication bus connecting the processor 1110, the memory 1120, and the communication interface 1130.

The memory 1120 includes, but is not limited to, a RAM, a ROM, an EPROM, or a CD-ROM, and is configured to store related instructions and data.

The communication interface 1130 is configured to receive and transmit data.

The processor 1110 may be one or more CPUs. If the processor 1110 is a CPU, the CPU may be a single-core CPU or a multi-core CPU.

The processor 1110 in the network device 1100 is configured to read at least one program 1121 stored in the memory 1120, to perform the following operations: configuring a first timer, where the first timer is started after a first WUS is monitored by a terminal, and a duration of the first timer represents a duration for the terminal to monitor a first paging DCI or a second WUS, the second WUS is used for triggering start of a second timer by the terminal, and a duration of the second timer represents a duration for the terminal to monitor a second paging DCI.

It should be noted that, for the implementation of each operation, reference can be made to the corresponding elaboration in the method embodiments illustrated in FIG. 2, and the network device 1100 may be configured to perform the method at the network device side in the foregoing method embodiments of the disclosure, which will not be described again herein.

Embodiments of the disclosure further provide a computer-readable storage medium. The computer-readable storage medium is configured to store computer programs for electronic data interchange (EDI). The computer programs are operable with a computer to perform some or all of the steps of the terminal or the network device described in the foregoing method embodiments.

Embodiments of the disclosure further provide a computer program product. The computer program product includes computer programs. The computer programs are operable with a computer to perform some or all of the steps of the terminal or the network device described in the foregoing method embodiments. The computer program product may be a software installation package.

It is to be noted that, for the sake of brevity, the foregoing embodiments are described as a series of action combinations. However, it will be appreciated by those skilled in the art that the disclosure is not limited to the sequence of actions described. According to embodiments of the disclosure, some steps may be performed in other orders or simultaneously. In addition, it will be appreciated by those skilled in the art that the embodiments described in the specification are preferable embodiments, and the actions, steps, modules, or units involved are not necessarily essential to the disclosure.

In the foregoing embodiments, the elaboration of each embodiment has its own emphasis. For the parts not described in detail in one embodiment, reference may be made to related elaborations in other embodiments.

Those skilled in the art should understand that some or all of the functions of the methods, steps, or related modules/units described in embodiments of the disclosure may be implemented through software, hardware, firmware, or any other combination thereof. When implemented by software, all or some of the functions may be implemented in the form of a computer program product, or may be implemented by a processor executing computer program instructions. The computer program product includes one or more computer program instructions, where the computer program instruction may be consist of corresponding software modules. The software module may be stored in a RAM, a flash memory, a ROM, an EPROM, an electrically EPROM (EEPROM), a register, a hard disk, a mobile hard disk, a CD-ROM, or any other form of storage medium well known in the art. The computer program instruction may be stored in a computer-readable storage medium, or transmitted from one computer-readable storage medium to another computer-readable storage medium. For example, the computer program instruction may be transmitted from one website, computer, server, or data center to another website, computer, server, or data center in a wired manner or in a wireless manner. The computer-readable storage medium may be any computer accessible usable-medium or a data storage device such as a server, a data center, or the like which integrates one or more usable media. The usable medium can be a magnetic medium (such as a soft disc, a hard disc, or a magnetic tape), an optical medium, or a semiconductor medium (such as a solid state disk (SSD)), etc.

Each module/unit in various devices or products described in the foregoing embodiments may be a software module/unit or a hardware module/unit, or some may be a software module/unit and the rest may be a hardware module/unit. For example, with regard to various devices or products applied to or integrated into a chip, various modules/units included therein may all be implemented by means of hardware such as a circuit; or at least some of the modules/units may be implemented by means of a software program run on a processor integrated in the chip, and the rest (if any) modules/units may be implemented by means of hardware such as a circuit. The same also applies to various devices or products applied to or integrated into a chip module or various devices or products applied to or integrated into a terminal.

The objectives, technical solutions, and advantages of embodiments of the disclosure are described in detail in the foregoing implementations. It should be understood that, the foregoing elaborations are merely some implementations of the embodiments of the disclosure, but are not intended to limit the protection scope of the embodiments of the disclosure. Any modifications, equivalent replacements, improvements, and the like made based on the technical solutions of the embodiments of the disclosure shall all fall within the protection scope of the embodiments of the disclosure.

I/We claim:

1. A monitoring method, comprising:
starting a first timer after a first wake-up signal (WUS) is monitored; and
monitoring a first paging downlink control information (DCI) or a second WUS before the first timer expires, wherein the second WUS is used for triggering start of a second timer by a terminal, and a duration of the second timer represents a duration for the terminal to monitor a second paging DCI.

2. The method of claim 1, wherein
a duration of the first timer or the duration of the second timer is pre-configured; or
the duration of the first timer or the duration of the second timer is configured by a network: or
the duration of the first timer or the duration of the second timer is determined according to first interval length information and duration ratio coefficient information configured by the network, wherein the first interval length information indicates a time interval between when the first WUS is currently monitored by the terminal and when the first WUS is monitored last time by the terminal.

3. The method of claim 1, wherein the first WUS is used for triggering transition of the terminal to a second state from a first state.

4. The method of claim 3, wherein
the first state comprises a deep sleep state, a power-off state, or a flight mode;
the second state comprises a radio resource control (RRC) idle state, an RRC inactive state, or an RRC connected state.

5. The method of claim 3, wherein power consumption of the terminal in the first state is lower than power consumption of the terminal in the second state.

6. The method of claim 1, wherein before monitoring the first paging DCI or the second WUS, the method further comprises:
obtaining configuration information; and
determining a first resource location according to the configuration information before the first timer expires, wherein the first resource location is used for monitoring the first paging DCI or the second WUS.

7. The method of claim 6, wherein the configuration information is carried in a system message, or the configuration information is configured by an RRC layer or an upper layer.

8. The method of claim 6, wherein the configuration information comprises paging configuration parameter information or wake-up configuration parameter information, wherein
the paging configuration parameter information is used for configuring a paging occasion (PO);
the wake-up configuration parameter information is used for configuring the first resource location.

9. The method of claim 8, wherein in response to the configuration information comprising the paging configuration parameter information, determining the first resource location according to the configuration information comprises:
determining at least one first PO according to the paging configuration parameter and device identity (ID) information of the terminal, and taking the at least one first PO as the first resource location.

10. The method of claim 8, wherein the wake-up configuration parameter information comprises at least one of: offset information or period information, wherein
the offset information is used for configuring an offset from an ending position of the first WUS to a starting resource position of the first resource location;
the period information is used for configuring a period of the first resource location.

11. The method of claim 8, further comprising:
starting the second timer according to the second WUS in case the first timer expires and the second WUS is monitored by the terminal; or
starting the second timer by default in case the first timer expires and the second WUS is not monitored by the terminal, or not starting the second timer by default by the terminal in case the first timer expires and the second WUS is not monitored by the terminal.

12. The method of claim 11, further comprising:
determining at least one second PO according to the paging configuration parameter information and device ID information of the terminal before the second timer expires, in case the second timer is started by the terminal and the configuration information comprises the paging configuration parameter information; and
monitoring the second paging DCI at the at least one second PO.

13-21. (canceled)

22. A terminal, comprising a processor, a memory storing at least one program, and a communication interface, wherein the at least one program are operable with the processor to:
a processing unit configured to:
start a first timer, after a first wake-up signal (WUS) is monitored with the communication unit; and
monitor a first paging downlink control information (DCI) or a second WUS with the communication unit before the first timer expires, wherein the second WUS is used for triggering start of a second timer, and a duration of the second timer represents a duration of monitoring a second paging DCI.

23. The terminal of claim 22, wherein
a duration of the first timer or the duration of the second timer is pre-configured; or
the duration of the first timer or the duration of the second timer is configured by a network; or
the duration of the first timer or the duration of the second timer is determined according to first interval length information and duration ratio coefficient information configured by the network, wherein the first interval length information indicates a time interval between when the first WUS is currently monitored by the apparatus and when the first WUS is monitored last time by the apparatus.

24. The terminal of claim 22, wherein the first WUS is used for triggering transition of the apparatus to a second state from a first state.

25. The terminal of claim 24, wherein
the first state comprises a deep sleep state, a power-off state, or a flight mode;
the second state comprises a radio resource control (RRC) idle state, an RRC inactive state, or an RRC connected state.

26. The terminal of claim 24, wherein power consumption of the apparatus in the first state is lower than power consumption of the apparatus in the second state.

27. The terminal of claim 22, wherein the processing unit is further configured to:
before monitoring the first paging DCI or the second WUS,
obtain configuration information; and
determine a first resource location according to the configuration information before the first timer expires, wherein the first resource location is used for monitoring the first paging DCI or the second WUS.

28. The terminal of claim 27, wherein the configuration information is carried in a system message, or the configuration information is configured by an RRC layer or an upper layer.

29-44. (canceled)

45. A non-transitory computer-readable storage medium configured to store computer programs for electronic data interchange (EDI), wherein the computer programs are operable with a computer to perform the following:
starting a first timer after a first wake-up signal (WUS) is monitored; and
monitoring a first paging downlink control information (DCI) or a second WUS before the first timer expires, wherein the second WUS is used for triggering start of a second timer by a terminal, and a duration of the second timer represents a duration for the terminal to monitor a second paging DCI.

46. (canceled)
